(19) United States
(12) Patent Application Publication
(10) Pub. No.: US 2012/0330758 A1
(43) Pub. Date: Dec. 27, 2012

(54) SEGMENTING AD INVENTORY BY CREATORS, RECOMMENDERS AND THEIR SOCIAL STATUS

(76) Inventors: SUDHIR KAUSHIK, Sunnyvale, CA (US); Danielle Barbieri, San Jose, CA (US)

(21) Appl. No.: 13/164,966

(22) Filed: Jun. 21, 2011

(51) Int. Cl. G06Q 30/00

(52) U.S. Cl. 705/14.73

(57) ABSTRACT

Techniques are disclosed which allow content publishers to segment and assign differential CPMs (cost per 1000 impressions) to their ad inventory depending on the source of that inventory, the person consuming the inventory and the weight of the relationship in runtime to the ad platform, i.e., based on the kind of user and his/her position within a social community. Content generated by more influential/popular users may have higher CPM ads associated with them.

### TECHNICAL FIELD

Embodiments presented in this disclosure generally relate to online advertising networks. More specifically, embodiments presented herein allow a publisher to segment ad inventory by creators, recommenders and social status in on-line communities.

### BACKGROUND

“Ad inventory” generally refers to on-line content available to be associated with an advertisement, e.g., a web page or streaming video clip. For example, assume a website presents a short advertisement prior to presenting a streaming video clip to a user, as well as presents two interstitial advertisements as part of video playback. In such a case, each streaming video property provides three units of ad inventory.

On-line advertising systems for both banner and video ads typically tie ad inventory to a specific web site (banner and video), web page (banner) or a specific piece of content (video). Tying ad inventory to a specific web sites, pages, or streaming media content largely assumes that the value of the on-line ad inventory is driven by where the ad appears on a web page or what content the ad is associated with. While these factors do impact the value of ad inventory, this assumption breaks in the current social website world, where communities are an integral part of a site and where ad inventory is regularly created by user-submitted content (e.g., as part a blog posts by a contributing author or video clips submitted by users). As a result, the source of content on a given site is not homogenous. Some content may be contributed by “average” users while other content may be contributed by users are more influential in the community, i.e., users who drive a lot of traffic and engagement. Similarly, some specialized communities of interest develop around particular topics. Within such communities (or sub-communities) particular individuals may contribute highly influential or engaging content—at least to that community of interest—while at the same time, contribute content of more “average” interest outside of that community—even on the same web site.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an example computing infrastructure used to provide advertising content to different client systems, according to certain embodiments of the present disclosure.

FIG. 2 illustrates an example computing system used to distribute content along with advertisements from an ad network, according to certain embodiments of the present disclosure.

FIG. 3 illustrates an example of a client computing system used view online content presented with advertisements, according to certain embodiments of the present disclosure.

FIG. 4 illustrates a method 400 for segmenting ad inventory by creators, recommenders and their social status and for selecting advertisements to present along with hosted content, according to certain embodiments of the present disclosure.

FIG. 5 illustrates an example of a web-based interface used to present contributed content hosted by a social network site or other online community, according to certain embodiments of the present disclosure.

### DESCRIPTION

### Overview

Embodiments presented herein relate to techniques for segmenting ad inventory by creators, recommenders and their social status within online communities. One embodiment provides a method for presenting advertisements to users of an online community. The method may generally include determining that a first user is accessing content contributed by a second user of a plurality of content contributors within an online community, identifying a social status of the second user within the online community; and returning a first advertisement to a client device operated by the first user. A value of the first advertisement is determined, at least in part, on the basis of the identified social status of the second user within the online community.

In a particular embodiment, the method may further include passing a request for the first advertisement to an advertisement server. The request includes an indication of the identified social status associated with the second user. In such a case, the method may further include determining a social status of a third user within the online community, where the third user recommended the content to the first user, and the request also includes an indication of the identified social status associated with the third user. In another embodiment, the method may also include identifying a social status of the first user within the online community, and the request also includes an indication of the identified social status associated of the first user.

Additional embodiments include a computer readable storage medium, storing a program configured to perform the aforementioned method, and a system having a processor and a memory storing a program configured to perform the aforementioned method.

### DESCRIPTION OF EXAMPLE EMBODIMENTS

On social media web sites, users can contribute a variety of content such as blog posts on a blog hosting service, status or commentary posts on social networking sites, content uploaded to video sharing sites, etc. These and other similar contributions represent ad inventory for the service hosting an online community. Embodiments presented in this disclosure provide techniques for content publishers to segment ad inventory contributed by users in order to increase a value metric associated with advertisements presented alongside content contributed by certain users. For example, the publisher may receive higher CPMs (cost per 1000 impressions) for ad inventory contributed by certain “popular” users within a social community. As is known, CPM generally refers to advertising bought on the basis of impression. The price paid for CPM advertising is determined by multiplying the CPM rate by the number of CPM impressions. For example, one million impressions at $10 CPM equal a $10,000 total price. The higher the CPM rate, the more the publisher is paid for presenting impressions to users.

In one embodiment, a publisher may drive a higher CPM, e.g., based on the contributor of ad inventory and the social standing of the contributor within communities hosted by the publisher, the person consuming the inventory and the weight of the relationship (if any) between the contributor and the consumer. For example, ad inventory may be segmented based on a user type assigned to a contributing user (e.g., a as being an expert on a particular topic) or based on his/her position or standing within a social community (e.g., as being a user “followed” by a large group of other users). Content generated/contributed by more influential or popular users, or by users recognized as having specific subject-matter expertise (either generally or within specialized communities or sub communities) may have higher CPMs associated with them than content contributed by other users. A higher CPM may be justified for content originating from these sorts of influential, popular, or professional users, as such content may result in greater engagement and traction for advertisements presented with such content. Note, the actual approach or factors for determining a user type or whether a given user is an “influencer” generally (or relative to the user consuming ad inventory) may be tailored to suit the needs of a particular case.

More generally, embodiments presented herein provide content publishers/distributors with techniques for segmenting their ad inventory by the nature of the users originating that content and for providing this information as parameters to an ad server platform integrated with the content publisher/distributor. Doing so allows the publisher or distributor to better associate higher CPM ads with content originating from high-value members of an online social community. Similarly, the weight of the relationship between the creator/contributor of the inventory and the consumer of the inventory could be passed at run-time to the ad platform resulting in differential CPMs based on relationships between who is creating and consuming the inventory.

Note, the following description is presented to enable one of ordinary skill in the art to make and use the proposed techniques. Descriptions of specific embodiments and applications are provided only as examples and various modifications will be readily apparent to those skilled in the art. The general principles described herein may be applied to other embodiments and applications without departing from the scope of the disclosure. Thus, the present disclosure is not to be limited to the embodiments shown, but is to be accorded the widest scope consistent with the principles and features described herein. For purpose of clarity, features relating to technical material that is known in the technical fields related to the proposed ideas have not been described in detail.

Further, certain embodiments are described herein using an example of a social media website where video clips (i.e., ad inventory) contributed by users of the website are presented to other users, along with advertisements. For example, a social media website may allow users to upload video content and, optionally, metadata describing the uploaded video content. Thereafter, other users of the social media website may search for video clips based on the metadata or the identity of the contributing user (or according to other criteria). Further, users viewing content may rate the quality of the content as well as supply additional metadata describing the content. Over time, content contributed by highly rated users may be segmented for higher CPM advertisements. Similarly, content contributed by highly followed users may be segmented for higher CPM advertisements. Note, a highly followed user may be defined as one having a specific number of “friends” or “followers.” While a highly rated user may also be highly followed, a highly rated user may also be a subject matter expert on a given topic without having the requisite number of “friends” or “followers.” Further, content contributed by an otherwise “average user” on a specific subject matter known to be of interest to another user or sub-community of users may be deemed to be “highly followed” user for purposes of that content and segmented for higher CPM advertisements accordingly.

Also, embodiments disclosed herein for segmenting ad inventory for content presented (with advertisements) on a web page rendered by a web browser may readily be adapted for a variety of devices, including, e.g., desktop computers, mobile phones, game consoles, tablet computing devices, etc., capable of accessing online social networks using a web browser or other specialized application. Similarly, embodiments disclosed herein may readily be adapted for a variety of consumer electronics devices such as televisions, cable boxes, specialized streaming devices, DVD and Blu-ray® disk players that allow users to post, browse, and consume content from a publisher/distributor (e.g., from a video sharing service, blog hosting service or social networking websites). Further still, one of ordinary skill in the art will recognize that embodiments presented herein may also be adapted for audio-only content, e.g., streaming internet radio services or podcasts) where advertisements are either presented on a display screen or interstitial advertisements are presented as part of an audio stream.

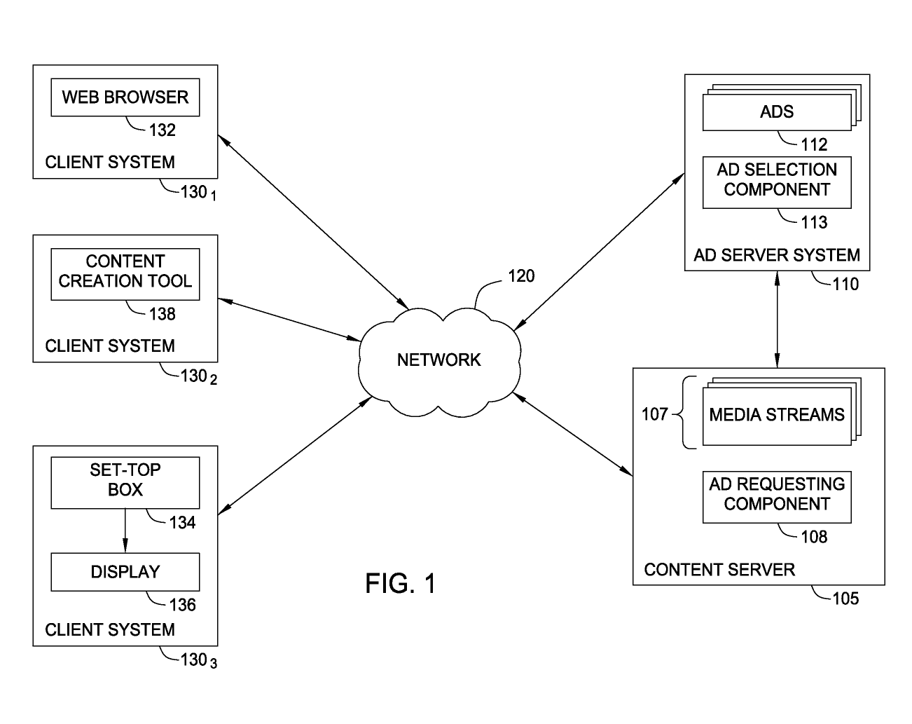

FIG. 1 illustrates an example computing infrastructure used to provide advertising content to different client systems, according to certain embodiments of the present disclosure. As shown, the computing infrastructure 100 includes a content server computer system 105, an ad server system 110, and a plurality of client systems 130₁₋₃ (illustratively three are shown, although there may be any number of clients), each connected to a communications network 120.

Illustratively, the client systems 130₁₋₃ communicate with the content server system 105 and the ad server system 110 over the network 120 to both post and download media content (shown as media streams 107) and to download advertisements presented with downloaded media content (shown as ads 112). The ads 112 may be presented alongside the content, as in the case of a banner ad or an overlay, or may be presented as an interstitial ad interrupting playback of one of the media streams 107. In one embodiment, an ad requesting component 108 is configured to determine when to include an advertisement in content distributed to one of the client systems 130₁₋₃. For example, the ad requesting component 108 may request an ad 112 (or a link to an ad 112) to include in a web page served to one of the client systems 130₁₋₃ Such an ad 112 is then available to be presented alongside user generated content such as a blog post, social network status post, status message or video clip.

When an ad 112 (or link to an ad 112) is needed, the ad requesting component 108 may identify a user that contributed the ad inventory being consumed (i.e., the “contributor”), the person/entity consuming the inventory (i.e., the “consumer”), and the weight of a relationship (if any) between the contributor and the consumer. While a variety of approaches for segmenting ad inventory may be used, in one embodiment, each user may be associated with one or more tags indicating their social status within a given online community (or sub community). For example, a contributor might be tagged as being a “highly followed” within a community on a social network web site relative to content on a particular topic of interest to the specific community, but tagged as an “minimally followed” on the social network website as a whole. Similarly, a consumer, contributor or both may be tagged as being interested in certain topics of interest or members of specified community groups, or as being friends or friends-of-friends, etc.

When requesting an ad 112 (or link to an ad 112), the ad requesting component 108 may pass along information to the ad selection component 113 that includes the social status of the contributor, the social status of the contributor, the relationship between them (if any). Further, the ad requesting component 108 may also pass along an indication of a social status of a recommender (i.e., a user who recommends content to the consumer). The ad requesting component 108 may also pass metadata describing the placement or positioning of the ad on a web page or metadata about the ad inventory as well.

When the resulting ad inventory (e.g., one of the media streams 107) is deemed to be higher value based on being created/posted/recommended by a user tagged as being “highly followed” or otherwise being a contributor/recommender of influential content, the ad selection component 113 can provide ads having a higher CPM. This results because the publisher can predict that the content provided by highly influential users may result in higher engagement. Thus, ad inventory created by users tagged as being a “highly followed individual” or recommended by a user tagged as being “highly followed individual” may result in ad selection with a higher CPM.

In this particular example, client system 130₁ represents a computer system running a web-browser 132. Accordingly, client system 130₁ is representative of desktop PCs, laptop computers, home-theater PCs, tablet computers and other computing systems capable of running a web-browser. In such a case, the web-browser 132 is configured to render web pages served from the content server platform 105. Such pages may allow users to select to view media streams 107 or otherwise navigate content provided by an online social networking website. In addition to consuming content, users can contribute content to many social networking sites. Accordingly, FIG. 1 includes client system 130₂, which represents a computer system like client system 130₁ In this example, the client system 130₂ is running a content creation tool 138. In one embodiment, the content creation tool 138 may provide a web-based interface that allows users to upload content (e.g., new media streams 107) to the content server 105. Of course, the content creation tool 138 could be used to post other types of user generated content, such as blog posts, status messages, and podcasts, etc., as well as consume content using a web browser (as shown for client system 130₁).

Client system 130₃ represents a set-top device connected to both network 120 and a display 136 (e.g., a flat-panel display). Accordingly, client system 130₃ is representative of digital cable boxes, digital video recorder (DVR) systems, video gaming consoles and other specialized streaming media devices, as well as DVD players capable of connecting to a network 120 and receiving media streams 107 provided by content server platform 105. Further, display 136 may itself be an integrated device capable of connecting to the network 120 playing back media streams 107. For example, some flat-panel television displays include integrated firmware components used to connect to a variety of content server platforms 105 (e.g., firmware components used to access various streaming media services, video on demand services, or social network sites, or firmware components configured to provide general web browsing capabilities). In each of these cases, the interface presented to users may allow users to interact with an online community such as a social networking website and to select browse content (i.e., consume ad inventory segmented by creators, recommenders and social status).

As noted, content server platform 105 provides a computing system configured to transmit media streams 107 to clients 130₁₋₃. For example, content server platform 107 may provide a web-server configured to respond to requests for web pages received from web-browser 132. Similarly, ad server platform 110 provides a computing system configured to respond to requests for ads delivered with the media streams 107. In one embodiment, ads 112 may be served directly to a client system 130. For example, the ads may be included as content supplied to web browser 132 for rendering. Alternatively, ads 112 may be supplied as links. In such a case, the web browser 132 fetches the linked advertisements when rendering web content (or while streaming one of the media streams 107). In another embodiment, the ad server 110 may be integrated as part of the content server 105. In such a case, the content server 105 may be configured to serve client systems 130₁₋₃ with both media streams 107 and ads 112.

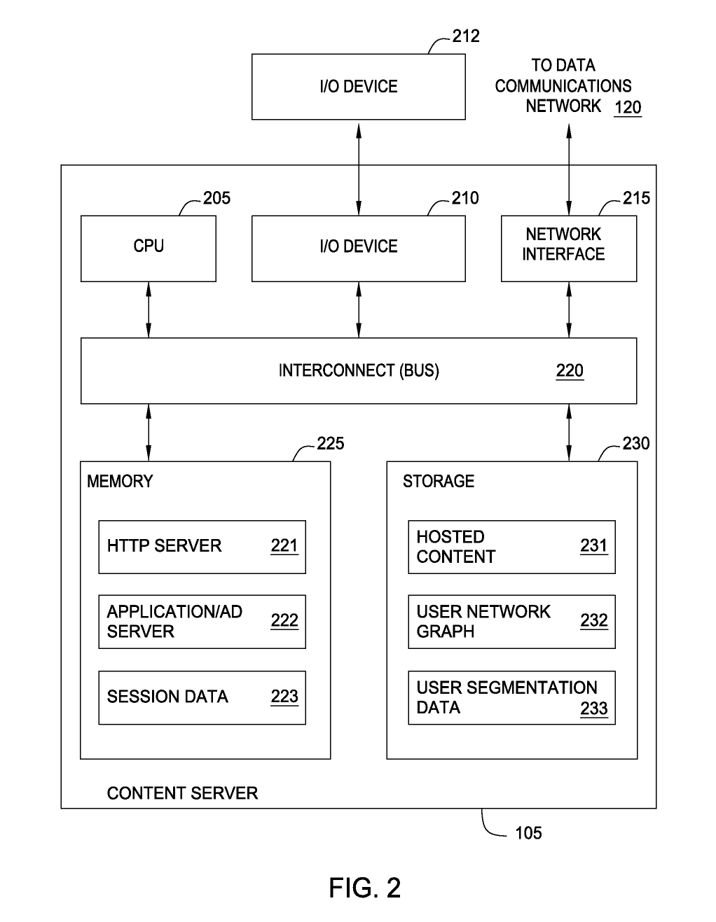

FIG. 2 illustrates an example of the content server system 105 first shown in FIG. 1, according to certain embodiments of the present disclosure. As shown, the content server 105 includes, without limitation, a central processing unit (CPU) 205, a network interface 215, an interconnect 220, a memory 225, and storage 230. The content server 105 may also include an I/O device interface 210 connecting I/O devices 212 (e.g., keyboard, display and mouse devices) to the content server system 105.

The CPU 205 retrieves and executes programming instructions stored in the memory 225. Similarly, the CPU 205 stores and retrieves application data residing in the memory 225. The interconnect 220 facilitates transmission, such as of programming instructions and application data, between the CPU 205, I/O devices interface 210, storage 230, network interface 215, and memory 225. CPU 205 is included to be representative of a single CPU, multiple CPUs, a single CPU having multiple processing cores, and the like. And the memory 225 is generally included to be representative of a random access memory. Although shown as a single unit, the storage 230 may be a combination of fixed and/or removable storage devices, such as fixed disc drives, floppy disc drives, tape drives, removable memory cards (in the form of Flash storage or some other non-volatile solid state storage),optical storage, network attached storage (NAS), or a storage area-network (SAN).

Illustratively, the memory 225 includes an HTTP server 221, an application server 222 and session data 223. And the storage 230 includes hosted content 231, user network graph 232 and user segmentation data 233. HTTP server 221 may provide a software application configured to respond to web page requests received from client systems 130₁₋₃ of FIG. 1. The HTTP server 221 may pass such a request to the application server 222, which generates HTML content for the HTTP server 221 to return to the client system 130₁. For example, in the present context, a user may navigate to a blog written by a user identified as being “highly followed” within an online community (or “highly followed” within a community of interest to the requesting user). As another example, the user may search for contributed video clips on a video sharing site, or user status messages or micro blog messages by keyword.

In response the application server 222 could segment the resulting ad inventory (i.e., the hosted content 231 presented in response to the user interaction) according to the social status of creators and/or recommenders of the hosted content 231. Doing so allows the content server 105 to drive a higher CPM for ads presented alongside hosted content 231 supplied by users with a social status of “highly followed” within the user network graph 232 and user segmentation data 233. In one embodiment, the user network graph 232 indicates relationships (e.g., followed and following) between users as well as membership in online communities or sub communities dedicated to topics of interest, allowing popular or influential contributors of hosted content 231 to be identified as such. As a simple example, a user may be tagged as “highly followed” after amassing a fixed number of followers generally, or amassing a number of followers who belong to the same community of interest. Of course, a variety of other approaches for ascertaining or assigning a social status to users may be employed.

Similarly, segmentation data 233 could also indicate the tendency of hosted content 231 contributed by a given user to be viewed by other users and any ratings assigned to the hosted content 231 by consuming users. In such a case, users contributing hosted content 231 highly rated by other users may be tagged as being “highly influential” or similar. As another example, if a first user consistently searches for or consumes hosted content 231 contributed by a second user, then that relationship may be used to drive a higher CPM for presenting new hosted content 231 contributed the second user, when consumed by the first user, but present ads at a “regular” CPM when that same content is presented to users that do not consistently seek out hosted content 231 contributed by the second user. The session data 223 may also track the ads presented to a given user navigating through hosted content 231, allowing responses to be tracked and preventing a user from being over saturated with the same advertisement.

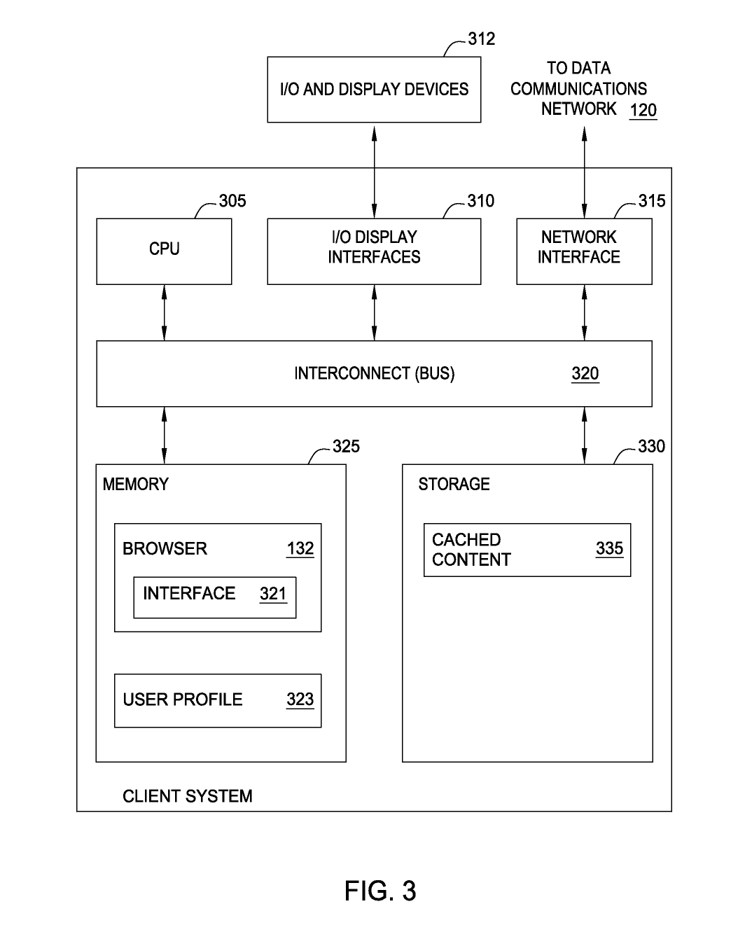

FIG. 3 illustrates an example of a client computing system used view online content presented with advertisements, according to certain embodiments of the present disclosure. As shown, the client computing system 130 includes, without limitation, a central processing unit (CPU) 305, a network interface 315, an interconnect 320, a memory 325, and storage 330. The computing system 130₁ may also include an I/O devices interface 310 connecting I/O devices 312 (e.g., keyboard, display and mouse devices) to the computing system 130₁.

Like CPU 205, CPU 305 is included to be representative of a single CPU, multiple CPUs, a single CPU having multiple processing cores, etc., and the memory 325 is generally included to be representative of a random access memory. The interconnect 320 is used to transmit programming instructions and application data between the CPU 305, I/O devices interface 310, storage 330, network interface 315, and memory 225. The network interface 315 is configured to transmit data via the communications network 120, e.g., to stream media or other hosted content, web pages, blog posts, etc., from the server system 105, as well as to receive and present ads 112 from the ad server system 110. Storage 330, such as a hard disk drive or solid state (SSD) storage drive, may store non-volatile data.

Illustratively, the memory 325 includes a web browser 132, which itself includes an interface 321 and user profile 323. And the storage 330 stores cached content 335. As is known, the browser 132 provides a software application which allows a user to access web pages and other content hosted by a server. In context of the present disclosure, the interface 321 corresponds to components of browser 132 used to access a social media site (e.g., the video sharing website used as an example above). In such a case, the interface 231 may download video clips stored in storage 330 as buffered media content 355. For example, interface 321 may be configured to playback media streams packaged as an Adobe® Flash® file, a Microsoft® Silverlight® package or an HTML5 object. Additionally, the interface 321 may also fetch ads presented contemporaneously with a given video clip (or as an interstitial interrupting playback of a video clip). An example of such an interface is described below in conjunction with FIG. 7. Of course, other approaches may be used to allow the client system 130₁ to render a user interface, as well as to receive and present ads 112 from the ad server system 110 along with hosted content 231. The user profiles may store information (e.g., as cookies) indicating what content a user has accessed, site configuration settings, what users a user is following, etc.

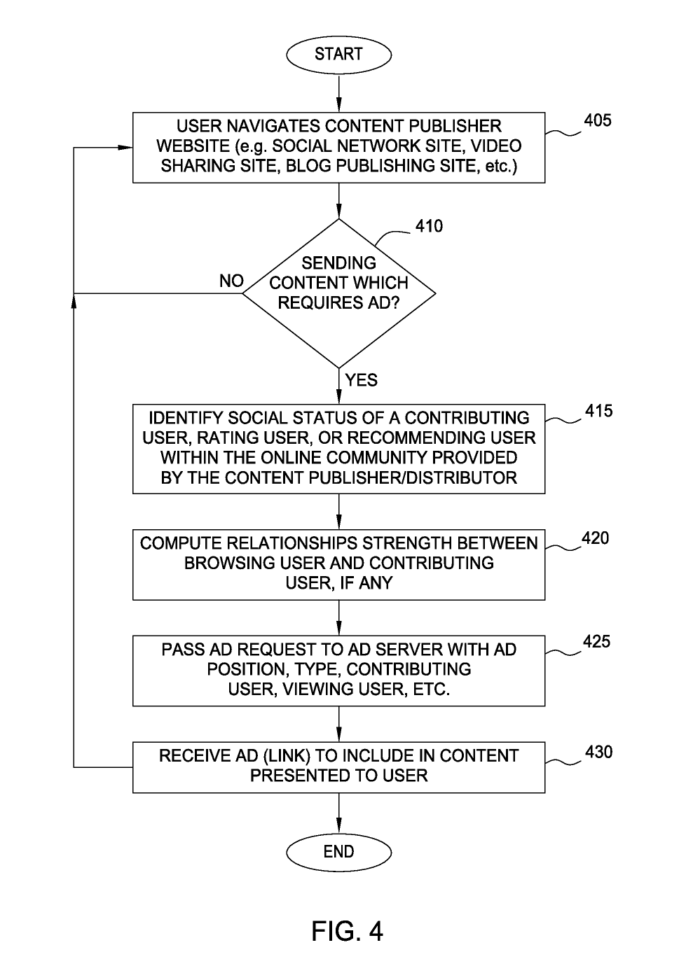

FIG. 4 illustrates a method 400 for segmenting ad inventory by creators, recommenders and their social status and for selecting advertisements to present along with hosted content, according to certain embodiments of the present disclosure. As shown, the method 400 begins at step 405, where a user navigates to a content publisher website such as a social network site, video sharing site, blog publishing site, etc. Alternatively, the user could interact with a client device configured to access online content hosted by such social media sites (e.g., a specialized application executed on a game console).

At step 410, the content publisher identifies whether the user is browsing content (or requesting to view content) which is presented along with advertisements. If so, the content publisher requests an ad (or a link to an ad) to include with requested content delivered for rendering or streaming on the client device. For example, a user may interact with an online video sharing web site to search for online video clips hosted by the content publisher using keywords associated with hosted content, by searching for clips posted by a given user or posted to a forum dedicated to a given topic. As in other examples, the user could also follow a recommendation to view an online clip or such a clip could be embedded within a blog post by a user tagged as being “highly followed” in an online blogging community. However encountered, the content to be transmitted to the user may include one or more online advertisements (or links to advertisements fetched by the client), where an ad server selects ads based, at least in part, on the social status of content creators/posters, and/or recommenders within the online community (or sub community).

Accordingly, at step 415 the content publisher may determine any information indicating that the advertising value of a particular item of ad inventory (e.g., video clip, blog post, etc.) is enhanced by the social status of a contributing user, rating user, or recommending user within the online community provided by the content publisher/distributor. For example, the content publisher/distributor hosting an online community may identify a user(s) (i.e., the contributor) that contributed the ad inventory that will be presented to a viewing user (the consumer) along with one or more advertisements. Once identified, any social status tags assigned to the contributor (and consumer) may be retrieved. Alternatively, the content requested by a user may have been highly rated by a threshold number of other users within the community (or sub community) or may have been recommended to the viewing user by a user identified as being a “highly followed” or otherwise as being influential within the online community generally, or with respect to a particular topic, forum, or sub-community.

At step 420, the content publisher may identify relationships between a viewing user and contributing user within the online community. For example, both the contributing user and viewing users may be part of an online community or forum dedicated to a particular topic. As another example, the viewing user may have a history of accessing content from the contributing user (or content on a particular topic contributed by the contributing user). Any of these (or other) relevant relationships between the viewing user and contributing user may be identified (and assigned a score or social status tag used to determine a relationship (if any) between a viewing users and a requesting user.

At step 425, once the social status of the viewing user, contributing user, and any recommending users are determined, this information may be passed in a request to the ad serving network. The content publisher may also pass metadata describing the placement or positioning of the ad on a web page (e.g., whether the requested add is placed as banner ad, an interstitial ad or other placement within a web page). The content publisher may also pass metadata about the ad inventory to the ad server. For example, the content publisher could pass a content rating or content tags determined from ratings/tags specified by viewing users to characterize the contributed content. In one embodiment, the content publisher is configured to use any combination of the social status of the contributing user, viewing user, recommending users, and relationships between such users (however represented), when requesting advertisements presented along with or alongside the hosted content. In particular, content contributed or recommended by users tagged as being “highly followed” or otherwise being influential within an online community generally (or relative to the particular ad inventory being presented to the viewing user) may result in advertisements with higher CPM for such content being presented to the viewing user.

Once the ad server receives the information from the content publisher/distributor, including the social status information, the ad server may select ads to return in response to the request. Additionally, the publisher distributor may command (or the distributing ad network may offer) a higher CPM for the ads presented with the content contributed by “highly followed” or “highly rated” users.

At step 430, the content publisher may receive an ad (or link to an ad) to include with hosted content presented to the user. Once received, the advertisement (or link where an advertisement may be fetched) is transmitted to the user along with the hosted content. For example, a banner ad could be rendered on a web page with a frame for viewing a streaming video clip. Similarly, the clip itself could include an advertising overlay and interstitial advertising could be inserted at points within the video clip. Of course, the type and placement of the advertisements may be tailored according to the hosted content being presented to the viewing user. Following step 430, the method 400 returns to step 405, where the viewing user continues to navigate, browse or stream content hosted by the online community. As additional requests for advertisements are needed, the content publisher may repeat steps 415-430 as frequently as appropriate during a given user session.

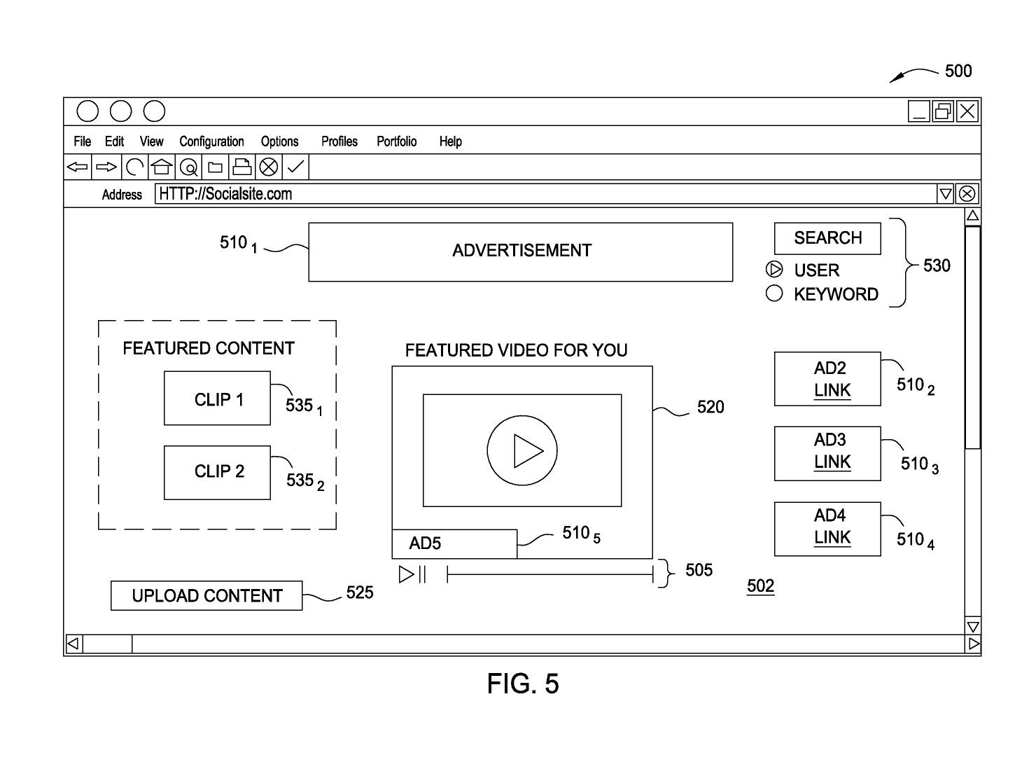

FIG. 5 illustrates an example of a web-based interface used to present contributed content hosted by a social network site or other online community, according to certain embodiments of the present disclosure. As shown, a web page 502 has been rendered in a browser window 500. The web page 502 includes a playback window 520 and a collection of user interface controls. The playback window 520 is used to present media content to the viewing user. In the example shown in FIG. 5, the media content comprises a video clip supplied by another user of an online social community. Browser window 502 also includes several advertisements 510. Illustratively, a banner ad 510₁ is shown at the top of the page 502 and link ads 510₂₋₄ are presented along the right side of the page 502. In one embodiment, the ads 510₁₋₄ may be configured to rotate periodically while the user navigates from one page to another or while viewing video clips presented in playback window 520. The controls 505 allow a user to start, pause, fast-forward, and rewind content, as well as swap between an in-window presentation and a full screen view of the media content presented in playback window 520.

Content in the playback window 520 could also include advertisements. For example, an overlay ad 510₅ is shown in the lower left corner of the playback window. Ad 510₅ may be configured to automatically fade out after a few seconds of playback or include a control used to close the ad 510₅ from being displayed during playback. Further, the interface 502 may allow a user to switch to a full-screen view to playback media content. In such a case, the ads 510₁₋₄ are no longer presented, leaving only the overlay ad 510₅ and any preview, interstitial, or post view ads presented as part of streaming the video clip in a full-screen mode. The interface 535 also includes links to additional featured content 535₁₋₂ merchandised to the viewing user, as well as controls 530 used to search the online community for other video clips (either by contributing user or by keyword). As described above, ads 510₁₋₅ may be selected by the ad server network, at least in part based on the social status of content creators/posters/viewers and/or recommenders within the online community (or sub community).

Advantageously, embodiments presented herein provide content publishers/distributors with techniques for using any combination of the social status of contributing users, viewing users, recommending users, and relationships between such users (however represented), to determine a CPM value for advertisements presented along with or alongside the hosted content. In one embodiment, the social status information is provided as parameters in requests sent to ad server platform for ads to present with content hosted by the content producer/distributor. Providing the social status of a contributing user with in an online community allows the publisher or distributor to better target ads and drive higher CPMs for content originating from high-value members of an online social community. Similarly, the weight of the relationship between the creator/contributor of the inventory and the consumer of the inventory could be passed at run-time to the ad platform resulting in differential CPMs based on relationships between who is creating and consuming the inventory.

While the forgoing is directed to embodiments of the present disclosure, other and further embodiments of the disclosure may be devised without departing from the basic scope thereof. For example, aspects of the present disclosure may be implemented in hardware or software or in a combination of hardware and software. One embodiment of the disclosure may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present disclosure, are embodiments of the present disclosure.

In view of the foregoing, the scope of the present disclosure is determined by the claims that follow.

We claim:

1. A computer-implemented method, comprising:
determining that a first user is accessing content contributed by a second user of a plurality of content contributors within an online community;
identifying a social status of the second user within the online community;
returning a first advertisement to a client device operated by the first user,
wherein a value of the first advertisement is determined, at least in part, on the basis of the identified social status of the second user within the online community.

2. The method of claim 1, further comprising passing a request for the first advertisement to an advertisement server, wherein the request includes an indication of the identified social status associated with the second user.

3. The method of claim 2, further comprising, determining a social status of a third user within the online community, wherein the third user recommended the content to the first user, wherein the request further includes an indication of the identified social status associated with the third user.

4. The method of claim 2, further comprising, identifying a social status of the first user within the online community, wherein the request further includes an indication of the identified social status associated with the first user.

5. The method of claim 1, wherein the advertisement comprises a link to advertisement content returned to the client device along with the accessed content.

6. The method of claim 1, wherein the advertisement server is integrated with a content server hosting the online community.

7. The method of claim 1, wherein the online community hosts a collection of online blogs, each maintained by one of the plurality of second user, and wherein the accessed content comprises a set of one or more blog posts authored by the second user.

8. A computer-readable storage medium storing code for execution by a central processing unit (CPU), wherein the code, when executed by the CPU, performs an operation, comprising:
determining that a first user is accessing content contributed by a second user of a plurality of content contributors within an online community;
identifying a social status of the second user within the online community;
returning a first advertisement to a client device operated by the first user,
wherein a value of the first advertisement is determined, at least in part, on the basis of the identified social status of the second user within the online community.

9. The computer-readable storage medium of claim 8, wherein the operation further comprises, passing a request for the first advertisement to an advertisement server, wherein the request includes an indication of the identified social status associated with the second user.

10. The computer-readable storage medium of claim 9, wherein the operation further comprises, determining a social status of a third user within the online community, wherein the third user recommended the content to the first user, wherein the request further includes an indication of the identified social status associated with the third user.

11. The computer-readable storage medium of claim 9, wherein the operation further comprises, identifying a social status of the first user within the online community, wherein the request further includes an indication of the identified social status associated with the first user.

12. The computer-readable storage medium of claim 8, wherein the advertisement comprises a link to advertisement content returned to the client device along with the accessed content.

13. The computer-readable storage medium of claim 8, wherein the advertisement server is integrated with a content server hosting the online community.

14. The computer-readable storage medium of claim 8, wherein the online community hosts a collection of online blogs, each maintained by one of the plurality of second user, and wherein the accessed content comprises a set of one or more blog posts authored by the second user.

15. A system, comprising:
a processor; and
a memory storing one or more application programs, which, when executed on the processor, are configured to perform an operation, comprising:
determining that a first user is accessing content contributed by a second user of a plurality of content contributors within an online community;
identifying a social status of the second user within the online community;
returning a first advertisement to a client device operated by the first user,
wherein a value of the first advertisement is determined, at least in part, on the basis of the identified social status of the second user within the online community.

16. The system of claim 15, wherein the operation further comprises, passing a request for the first advertisement to an advertisement server, wherein the request includes an indication of the identified social status associated with the second user.

17. The system of claim 16, wherein the operation further comprises, determining a social status of a third user within the online community, wherein the third user recommended the content to the first user, wherein the request further includes an indication of the identified social status associated with the third user.

18. The system of claim 16, wherein the operation further comprises, identifying a social status of the first user within the online community, wherein the request further includes an indication of the identified social status associated with the first user.

19. The system of claim 15, wherein the advertisement comprises a link to advertisement content returned to the client device along with the accessed content.

20. The system of claim 15, wherein the advertisement server is integrated with a content server hosting the online community.

21. The system of claim 15, wherein the online community hosts a collection of online blogs, each maintained by one of the plurality of second user, and wherein the accessed content comprises a set of one or more blog posts authored by the second user.

22. A computer-implemented method, comprising:
receiving, from a host of an online community, a request for an advertisement to present to a first user in conjunction with content hosted by the online community contributed by a second user, wherein the request includes an indication of a social status of the second user within the online community; and
returning an advertisement to the host of the online community, wherein a value of presenting the advertisement to the first user is determined, at least in part, on the basis of the identified social status of the second user within the online community.

23. The system of claim 16, wherein the operation further comprises, determining a social status of a third user within the online community, wherein the third user recommended the content to the first user, wherein the request further includes an indication of the identified social status associated with the third user.

24. The system of claim 16, wherein the operation further comprises, identifying a social status of the first user within the online community, wherein the request further includes an indication of the identified social status associated with the first user.
